(19) United States
(12) Patent Application Publication
(10) Pub. No.: US 2004/0028796 A1
(43) Pub. Date: Feb. 12, 2004

(54) Nutritional food product and process for its preparation

(76) Inventor: Michael Shemer, Haifa (IL)

Correspondence Address: BLANK ROME LLP, THE FARRAGUT BUILDING SUITE 1000, 900 17TH STREET NW, WASHINGTON, DC, 20006, US

(21) Appl. No.: 10/333,270

(22) PCT Filed: Jun. 24, 2001
(86) PCT No.: PCT/IL01/00574

(30) Foreign Application Priority Data
Jul. 24, 2000 (IL) 137470

(51) Int. Cl. A23K 1/00

(52) U.S. Cl. 426/615

(57) ABSTRACT

A nutritional “Humus”-like product consisting of a mixture of cooked ground soy-beans and sesame paste. In the product the weight ratio between sesame paste and cooked soy-beans is in the range of 5-50% on a wet soy-beam basis. The product conserves the nutritional value associated with the soy beans component, while possessing a desirable taste and texture of the chickpeas and sesame (Humus).

### FIELD OF THE INVENTION

The present invention relates to a novel nutritional product based on soy-beans, and to a process for its preparation.

### BACKGROUND OF THE INVENTION

Soy-beans are well recognized as raw materials for food product. They contain nutritious components, such as lecithin and proteins in amounts much higher than other natural products. The nutraceutical value of soy-beans has also been recognized lately by the FDA, and permission has been given, in October of 1999, to the food industry to indicate, in products containing at least 6,25 gr. protein per serving, that consuming the product reduces the risk of heart diseases. Other components, namely isoflavones, which are present almost exclusively in soy-beans, have been recognized in many researches to be useful in reducing the risk of cancer, especially in women.

It has been known for years that the occurrence of cancer in women is substantially lower in the Far East than in Western countries. Epidemiological studies have shown the relation between cancer and nutritional habits, and particularly soy consumption. Additional research has determined that this effect is connected to the consumption of phytoestrogens of the isoflavons family, and particularly genestein which is found in nature almost only in soy. In later studies it was found that the beneficial effect of isoflavons is enhanced by the presence of soy protein in the diet, and therefore the natural presence of both materials is vital.

In many food products containing soy protein the isoflavons are lost through the isolation processes of the protein. Soy protein concentrate, for instance, and soy chunks (TVP) based on the concentrate, which are among the most common soy base materials, do not contain almost any isoflavons. The main soy products which contain both the soy protein and the isoflavons are Tofu and soy milk. These products, commonly markets in the Far East, suffer from a strong off flavor which limits their acceptance in the Western World.

The use of soy beans to make soy pastes is known in the art. U.S. Pat. No. 4,432,999, the description of which is incorporated herein by reference, describes the preparation of a soy paste that incorporates a large quantity of whey solids. The product described in this patent aims at providing a solution for the large, unused amounts of whey solids which are a by-product of the cheese industry.

There are a number of pastes or dips currently consumed all over the world. Usually, however, these dips, while possessing a wholesome taste, do not contain nutritional components in a concentration and of the type provided by soy beans. One example of such a paste is the well known chickpeas paste, which when mixed with sesame paste, is also known under the name of “Humus”. The content of protein in the soy beans is approximately double that found in chickpeas. In addition, most vegetable proteins lack in one or two amino acids, namely lysine and methionine. Soy is richer in methionine than chickpeas, and by far richer in lysine, which makes it a much more valuable balanced protein. Average contents in these vegetables are shown in Table I:

TABLE I

| Component | Chickpeas | Soybeans |
|---|---|---|
| Protein (d.b. %) | 20 | 40 |
| Lysine (gr/100 gr. Protein) | 7.2 | 7.7 |
| Methionine (gr/100 gr. Protein) | 1.1 | 1.6 |

It should be also mentioned that the standard Humus product, prepared from chickpeas and available on the market has a disadvantage associated with the fact that it becomes quite inferior after being frozen and thawed since there is a visible fat separation in the product, which makes it unacceptable for the consumer.

In order to eliminate the separation of fat, additives of special stabilizers and emulsifiers are required. These additives however affect the texture of the product and deteriorate its taste.

Furthermore, the additives increase the cost of the product and make it less attractive for the consumer, since the ingredients list on the label becomes more complicated. This is the reason, why Humus product is seldom frozen, but only chilled in a refrigerator. However, Humus product has only 2-3 days shelf life when stored chilled without preservatives and it is difficult to stock the product for longer period as might be required for exporting.

The reason for the above mentioned separation phenomena lies in the fact that most of the oil in Humus is added during preparation of the product, since chickpeas, its main ingredient, contains little oil. Therefore the formulation contains plenty of non bound oil, which is very prone to separation during freezing. Soybeans, in comparison with chickpeas contains up to 20% of naturally occurring oil in the bean itself. Since this oil is naturally bound to the soy, it might be possible to freeze and to thaw “Humus”-like product made from soy without fat separation and without affecting the quality of the product.

It is therefore an object of this invention to provide a food product based on soy beans, that conserves its nutritional value, while possessing a desirable taste and texture which permit it to become a mainstream food product.

It is another purpose of this invention to provide a chickpeas and sesame paste (or Humus) substitute based on soy beans.

It is yet another purpose of the invention to provide a nutritional dip or paste or salad product, that can be made simply and inexpensively using soy beans as the base material.

It is still an object of the invention to provide soy products with a high nutritional fiber content, deriving from the utilization of the soy skins.

Yet another object of the invention is to provide soy products which has improved freeze-thaw characteristics, i.e. it can be stored frozen for a long period of time without using preservatives and it can be then thawed without fat separation and without loosing its taste properties.

Other purposes and advantages of this invention will appear as the description proceeds.

### SUMMARY OF THE INVENTION

It has now been surprisingly found that cooked whole soy-beans, when admixed with sesame paste and blended under appropriate conditions, result in a paste or dip that exhibits a desirable taste and pleasant texture and retains all the nutritional value of soy-beans.

It has further been found that, when produced appropriately and using a sufficient amount of sesame component, the resulting paste can be used as a chickpeas paste substitute, since it bears a very close resemblance to the taste and texture of Humus.

Thus, in one aspect, the invention is directed to a food product comprising a finely blended mixture of cooked ground soy-beans and sesame paste. According to a preferred embodiment of the invention the weight ratio between sesame paste and cooked soy-beans is in the range of 5-50%, on a wet soy-bean basis, more preferably, 15-30%.

It should be noted that the invention may employ soy-bean of any origin, including green soy-beans and genetically modified beans. Thus, the term “soy-bean”, as used herein, should be taken to embrace all soy-beans and soy-beans derived vegetable products, and the invention is by no means limited to the use of any particular soy-bean.

It is also possible, and in many cases desirable, to add to the food product of the invention spices, to improve the final taste.

The food product of the invention can be prepared in different final forms, which mostly differ in the final water and additives content. For instance, the product may have the consistency of a paste or of a dip. In a particularly preferred embodiment of the invention the product is chickpeas paste substitute.

The product of the invention retains the majority of the isoflavons and of the proteins naturally existing in soy, as well as natural fibers, if the skins are retained in the manufacturing process. The final product maintains a flavor and consistency suitable for Western taste.

The final product can be easily kept frozen for a long period of time without the necessity of stabilizers or emulsifiers and after being thawed it does not loose its taste and nutritional properties.

In another aspect, the invention is directed to a process for making a nutritional food product, comprising the steps of:

a) optionally, immersing the soy-beans in water for a period of time sufficient to soften the raw material and reduce cooling times;

b) optionally, removing the soy-beans skins;

c) cooking the soy-beans in water for a period of time of at least 30 minutes;

d) filtering off the water left after cooking;

e) allowing the soy-beans to cool, optionally, by cooling them in water; and

f) feeding the cold cooked soy-beans to a blender, together with raw sesame seeds and any flavors and/or additives.

According to a preferred embodiment of the invention the water used in Step (a) contains bicarbonate.

Cooking may be effected in a variety of ways and vessels. For instance, cooking can be effected in a continuous cooking extruder, or in batch mode.

Likewise blending can be effected in any suitable equipment, e.g., in a high-speed blender, and can also be done continuously.

The finished product is further processed by operations conventional in the food industry, such as packaging and refrigerating. Furthermore, conventional food preservatives, such as sodium benzoate and potassium sorbate could be added to extend the shelf life to several months.

Instead of cooling to make chilled refrigerated product, which is usually stored at +5 degrees C. one can employ freezing (preferably quick freezing) and then storing the product at −18 Degrees C.

By virtue of deep freezing it is possible to store the product for one year without addition of any conventional preservatives.

The frozen product is to be consumed after defrosting at ambient temperature or by any suitable means, e.g. in a refrigerator or a microwave oven.

### DETAILED DESCRIPTION OF PREFERRED EMBODIMENTS

The products according to the invention can be prepared according to the following general procedures:

Step 1: The soy-beans are immersed in water overnight. The water used for this purpose may contain other components, e.g., bicarbonate.

Step 2: (Optional) the soy-beans skins can be removed, if desired, although it is usually desired to keep them in the product, due to their nutritional value.

Step 3: The soy-beans are cooked in water for a period of time which typically is between 30 and 180 minutes under boiling or close to boiling conditions. Cooking can be effected in any suitable cooker, e.g., in a continuous cooking extruder, or in batch mode, or in a pressure cooker. The purpose of this cooking is to soften the hard beans and to remove the beany taste.

Step 4: Water is filtered off. Here, again, it is possible to remove the skins, if desired.

Step 5: (Optional): The soybeans are cooled in water.

Step 6: The cold cooked soy-beans are fed to a blender together with water and any flavors and/or additives, and ground. The weight ratio between sesame paste and cooled soybeans (on a wet basis) is 5-50%, the preferred range being 15-30%. The flavor and additives may include, e.g., spices, salt, lemon, etc. The blender may be of any suitable type, e.g., a high-speed blender, provided that it provides for the homogenous grinding and blending of the components.

Step 7: Sesame paste is added and blended together with the soybean paste.

Step 8: More water is added according to the required consistency, and spices according to taste.

Step 9: The resulting product is packaged and kept under refrigeration, ready for use.

Step 10: (Optional) The product after step 8 is frozen up to −18 Degrees C, preferably by quick freezing in appropriate equipment, and then kept frozen.

Step 11: (Optional) The frozen product is thawed at ambient temperature or in a microwave oven, or in any other suitable equipment and then consumed

The above will be further illustrated by the following examples:

### EXAMPLE 1

1 Kg of soy-beans were pre-washed and then left overnight in immersion in 10 Kg of water. At the end of this period the water was drained and the soy-beans were introduced into a jacketed kettle cooker with additional 10 Kg of water, were they were cooked at 95-100° C. for 180 minutes, after which the beans were cooled by mixing with water, and filtered of free water. The weight of the resulting cooked soy-beans was 2.5 Kg, indicating a water uptake of 1.5 Kg.

The resulting cooked soy-beans were then blended with 0.5 Kg of sesame paste, together with 0.5 Kg of additives, including salt, garlic and lemon to taste, as spices, and 0.5 Kg of water, at 1500 rpm for 5 minutes.

The resulting paste was ready for use. On analysis it was found to contain the major components listed in Table I below. The table also shows comparison results for a standard commercial humus. It should be noted that a small portion (100 gr.) of the product of Example 1 provides 100% of the daily requirement of the isoflavone of an adult women.

TABLE I

| Component | | Standard Commercial |
|---|---|---|
| per 100 gr. | Example 1 | Humous |
| Energy (Cal.) | 200 | 313 |
| Protein (gr.) | 14.8 | 7.0 |
| Carbohydrates (gr.) | 5.1 | 10.5 |
| Fat (gr.) | 13.4 | 27.0 |
| Saturated Fat (gr.) | 1.7 | 4.0 |
| Cholesterol (gr.) | 0 | 0 |
| Sodium (gr.) | 0.5 | 0.5 |
| Isoflavones (mg.) | 56 | 0 |

While embodiments of the invention have been described by way of illustration, it will be understood that the invention can be carried out by persons skilled in the art with many modifications, variations and adaptations, without departing from its spirit or exceeding the scope of the claims.

1. A food product comprising a finely blended mixture of cooked ground soy-beans and sesame paste.

2. A food product according to claim 1, wherein the weight ratio between sesame paste and cooked soy-beans is in the range of 5-50%, on a wet soy-bean basis.

3. A food product according to claim 2, wherein the ratio between sesame and cooked soy-beans is in the range of 15-30%.

4. A food product according to any one of claims 1 to 3, further comprising added spices.

5. A food product according to any one of claims 1 to 4, which is a paste.

6. A food product according to any one of claims 1 to 4, which is a dip.

7. A food product according to any one of claims 1 to 6, which is chickpeas paste substitute (humus).

8. A food product according to claim 1, comprising the majority of the isoflavons and of the proteins naturally existing in soy.

9. A product according to claim 8, further comprising natural fibers.

10. A product according to claim 1, having a flavor and consistency suitable for Western taste.

11. A product according to claim 5, in which said paste is chilled.

12. A product according to claim 6, in which said dip is chilled.

13. A product according to claim 5, in which said paste is frozen.

14. A product according to claim 6, in which said dip is frozen.

15. A product according to claim 5, in which said paste is defrosted.

16. A product according to claim 6, in which said dip is defrosted.

17. A process for making a nutritional food product, comprising the steps of:
a) optionally, immersing the soy-beans in water for a period of time sufficient to soften the raw material and reduce cooling times;
b) optionally, removing the soy-beans skins;
c) cooking the soy-beans in water for a period of time of at least 30 minutes;
d) filtering off the water left after cooking;
e) allowing the soy-beans to cool, optionally, by cooling them in water;
f) feeding the cold cooked soy-beans to a blender, together with raw sesame paste and any flavors and/or additives; and
g) adding water to the desired consistency.

18. A process according to claim 17, wherein the water used in Step (a) contains bicarbonate.

19. A process according to claim 17, wherein cooking is effected in a continuous cooking extruder.

20. A process according to claim 17, wherein cooking is effected in batch mode.

21. A process according to claim 17, wherein the weight ratio between sesame and soybeans is in the range 5-50%, on a wet soy-beans basis, preferably in the range of 15-30%.

22. A process according to claim 17, wherein the blender is a high-speed blender.

23. A process according to claim 17, further comprising conventional operations such as packaging and refrigerating the finished product.

24. A process according to claim 17, further comprising freezing operation, such as quick freezing.

25. A process according to claim 25, in which said freezing operation is carried out at −18 Degrees C.

26. A process according to claim 24, further comprising defrosting operation.

27. A process according to claim 26, in which said defrosting operation is carried out at ambient temperature.

28. A process according to claim 26, in which said defrosting operation is carried out in a microwave oven.

29. A process according to claim 26, in which said defrosting operation is carried out in a refrigerator.
